(19) United States
(12) Patent Application Publication
(10) Pub. No.: US 2019/0134657 A1
(43) Pub. Date: May 9, 2019

(54) SPRINKLER APPARATUS

(71) Applicants: DON DUFFIN, PAUL, ID (US); ROGER DUFFIN, PAUL, ID (US)

(72) Inventors: DON DUFFIN, PAUL, ID (US); ROGER DUFFIN, PAUL, ID (US)

(21) Appl. No.: 16/182,414

(22) Filed: Nov. 6, 2018

Related U.S. Application Data
(60) Provisional application No. 62/581,894, filed on Nov. 6, 2017.

(51) Int. Cl. B05B 15/658

(52) U.S. Cl. CPC B05B 15/658

(57) ABSTRACT

What is disclosed is a sprinkler apparatus and system for distributing a liquid preferably for use in an irrigation system. The sprinkler apparatus utilizes removable, replaceable, and interchangeable nozzles that are configured to vary the flow and/or location of a spray of water from the nozzle at a distributor. The distributor is configured to rotate to distribute the liquid flow from the distributor in a plurality of directions. The distributor utilizes a motor to control the flow of liquid from the distributor. Preferably a sprinkler is provided with multiple nozzles such that a user and/or consumer can select which nozzle flow is desired for implementation in a given situation.

### PRIORITY/CROSS-REFERENCE TO RELATED APPLICATIONS

This application claims the benefit of U.S. Provisional Application No. 62/581,894, filed Nov. 6, 2017, the disclosure of which is incorporated by reference.

### TECHNICAL FIELD

The herein disclosed and claimed inventive concepts generally relate to a sprinkler head, and more particularly to a nutation sprinkler head for randomizing water distribution.

### SUMMARY OF INVENTION

The purpose of the Summary of Disclosure is to enable the public, and especially the scientists, engineers, and practitioners in the art who are not familiar with patent or legal terms or phraseology, to determine quickly from a cursory inspection, the nature and essence of the technical disclosure of the application. The Summary of the Invention is neither intended to define the invention of the application, which is measured by the claims, nor is it intended to be limiting as to the scope of the invention in any way.

What is disclosed is a liquid distributing sprinkler having replaceable and/or interchangeable nozzles for use typically in an irrigation system distributing water to an agricultural field. The sprinkler has a frame. The sprinkler has a nozzle carrier configured to hold a nozzle. In a preferred embodiment the nozzle carrier is a tubular shape with a passageway through the nozzle carrier for the passage of fluid. The nozzle carrier is configured for removable attachment of a nozzle to an end of the nozzle carrier such that liquid flows through the nozzle carrier and out the nozzle. In a preferred embodiment a nut attaches to an end of the nozzle carrier to hold the nozzle to the nozzle carrier. Preferably the nut threads on to an end of the nozzle carrier, with the nozzle protruding through the nut. In a preferred embodiment the sprinkler has a seal positioned between the nozzle and the nozzle carrier to prevent fluid leakage between the nozzle and the nozzle carrier. The nozzle carrier can be directly or indirectly attached to an external fluid supply, such as an irrigation supply line. The nozzle directs water from the nozzle carrier at the distributor. The distributor spins to distribute water in outward direction, typically in a circular or semi-circular pattern, from the sprinkler. In a preferred embodiment the motor serves to dampen the speed rate of the distributor. In this embodiment the distributor spins in response to water hitting the distributor causing the distributor to rotate.

In a preferred embodiment the nozzle has a locating tab on a circumference of the nozzle. This locating tab mates with a corresponding void on the nozzle carrier to provide easy and quick proper alignment of the nozzle in the nozzle carrier.

In a preferred embodiment the nozzle carrier is removably attached to the frame. In a further preferred embodiment, the frame has a clamp for attaching said nozzle carrier to the frame. In a preferred embodiment the clamp is configured for circumvolving engagement with the nozzle carrier. In a preferred embodiment the circumvolving clamp utilizes a mechanism to adjust the circumference of the clamp around the nozzle carrier, thus loosening and tightening the clamping action of the clamp on the nozzle carrier. In a further embodiment the sprinkler utilizes a snap ring for connecting the nozzle carrier to the frame.

The clamping action of the frame on the nozzle holder can be achieved through a variety of mechanisms. For example, in one embodiment the clamp is circular shape defining a circumference. The clamp is configured to circumvolve the nozzle holder. The circumference of the clamp has a break or gap defined by a first clamp circumference end and a second clamp circumference end. The clamp adjustment mechanism utilizes a threaded connector spanning the gap and configured for adjusting the width of the gap between the first clamp circumference end and said second clamp circumference end, thus tightening or loosening the clamp. In a preferred embodiment the nozzle carrier has a locating tab that is configured for mating engagement with a void in the clamp or frame for aligning the nozzle carrier in the frame.

What is further disclosed is a sprinkler system that is provided having a plurality of interchangeable nozzles. The nozzles can be provided direct with the sprinkler described above, or provided separately. The nozzles preferably are provided with varying flow rates.

Still other features and advantages of the claimed invention will become readily apparent to those skilled in this art from the preceding detailed description of preferred embodiments of the invention, simply by way of illustration of the best mode contemplated by carrying out my invention. As will be realized, the invention is capable of modification in various obvious respects all without departing from the invention. Accordingly, the description of the preferred embodiments are to be regarded as illustrative in nature, and not as restrictive in nature.

### BRIEF DESCRIPTION OF THE DRAWINGS

FIG. 1 is a right cutaway view of a preferred embodiment of a sprinkler apparatus.

FIG. 2 is an exploded view of a preferred embodiment of a sprinkler apparatus.

FIG. 3 is an isometric view of a preferred embodiment of a sprinkler apparatus.

FIG. 4 is a right view of a preferred embodiment of a sprinkler apparatus.

FIG. 5 is a back view of a preferred embodiment of a sprinkler apparatus.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

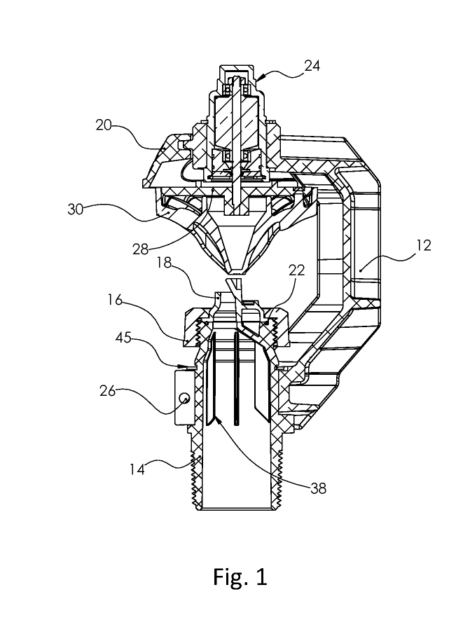

Certain preferred embodiments of the disclosed technology are shown in FIGS. 1 through 5.

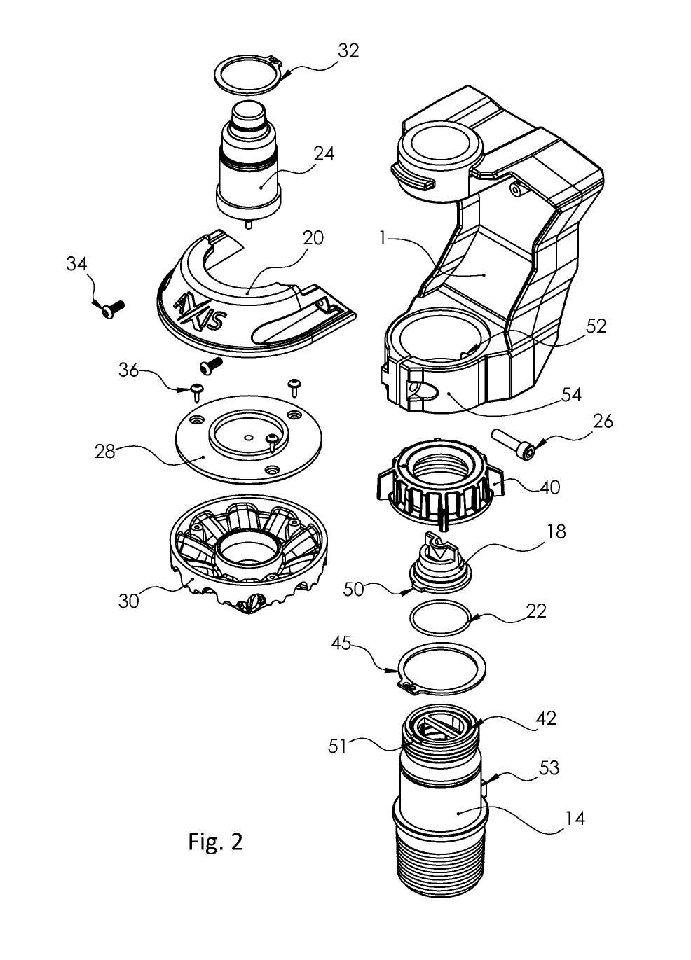

FIGS. 1 through 5 depict a preferred embodiment of a sprinkler apparatus. FIG. 1 is a right cutaway view of the sprinkler apparatus 10. In the preferred embodiment the sprinkler apparatus utilizes a frame 12. The frame has mounted thereon a distributor 30 and a motor 24 that controls the spin of the distributor. In the depicted embodiment the distributor is connected to the motor by a distributor plate 28 (shown in FIG. 2) which is connected to the distributor by fasteners 36. The frame attaches to a nozzle carrier 14 to which a nozzle 18 is attached. In a preferred embodiment the nozzle utilizes a locator tab 50 that is matingly receivable in a void 51 of the nozzle carrier. In the preferred embodiment, the nozzle 18 can be configured in a variety of shapes and sizes to vary the liquid stream to the distributor. The nozzle carrier and nozzle are configured such that water flows through the nozzle carrier and through the nozzle which directs the liquid in a spray to the distributor. In the depicted embodiment the nozzle carrier utilizes vanes 38 for reducing turbulence in the liquid stream as it enters the nozzle.

In the depicted embodiment a nut 16 attaches the nozzle 18 to the nozzle carrier 14. The nut threads on to an end of the nozzle carrier. The nozzle is thus compressed onto the nozzle carrier. A seal 22 serves to prevent liquid leakage at the connection of the nozzle to the nozzle carrier.

In the depicted embodiment, the frame utilizes a clamp 54 and a snap ring 45 to connect the nozzle carrier to the frame. In the depicted embodiment the nozzle carrier utilizes a locating tab 53 that is matingly receivable with a void 52 in the frame or clamp. The clamp can then be loosened or tightened around the nozzle carrier by utilizing coupler which is threaded in an embodiment and configured for threaded engagement in the clamp. The coupler 26 locks the sprinkler apparatus 10 together once assembled. The clamp and coupler 26 aide in maintaining alignment of the sprinkler when in use.

In the depicted embodiment, the shield 20 is a primarily an ornamental piece that covers the front of the frame 12 but also acts to prevent water from penetrating the inner workings of the sprinkler apparatus 10. In the depicted embodiment the shield is connected to the frame by connectors 34.

FIG. 2 is an exploded view of the sprinkler apparatus shown in FIG. 1. The motor 24 sits in the upper portion of the frame 12 fastened by a clamp 32. The adapter plate 28 is attached to the distributor 30 by use of a third coupler 36. The shield 20 is secured to the frame 12 using the second coupler 34. The nozzle carrier 14 is fastened to the frame 12 using a coupler 26. The O-ring 22 sits between the nozzle 18 and the nozzle carrier 14. The nozzle 18 is secured to the nozzle carrier 14 using the nut 16.

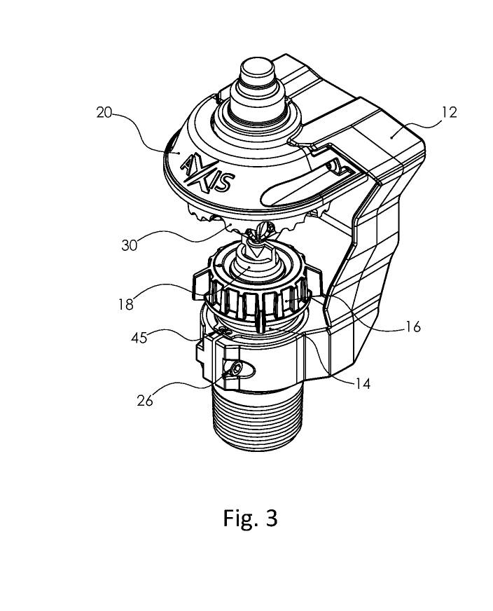

FIG. 3 is an isometric view of the sprinkler apparatus 10. In the preferred embodiment, the shield 20 is decorative, however, also serves to protect the inner workings of the sprinkler apparatus 10 from external elements. Seated in the frame 12 is the motor 24 which regulates the distributor 30. The nozzle 18 is secured to the nozzle carrier 14 by the nozzle nut 16. The coupler 26 secures the nozzle carrier 14 within the frame 12.

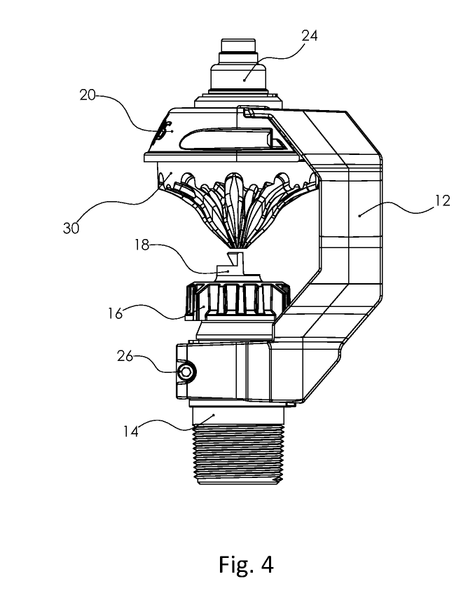

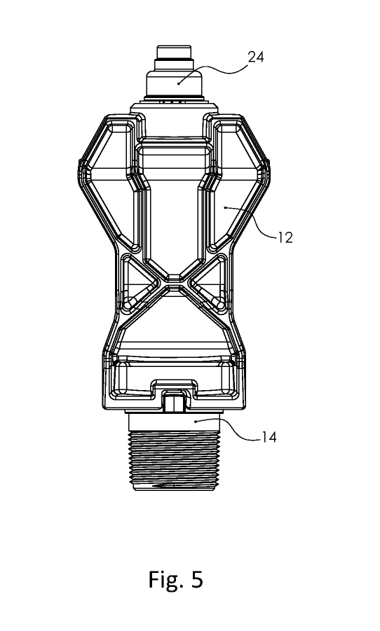

FIG. 4 is a right view of the sprinkler apparatus 10. In the preferred embodiment, the nozzle 18 receives water from the nozzle carrier 14 and sprays it to the distributor 30 which rotates slowly, controlled by the motor 24. The nozzle 18 is secured to the nozzle carrier 14 by the nozzle nut 16. The coupler 26 secures the nozzle carrier 14 within the frame 12. The shield 20 is a decorative piece; however, it also protects the inner workings of the sprinkler apparatus 10 from external elements. FIG. 5 is a back view of the sprinkler apparatus 10. The frame 12 comprises of the motor 24 which regulates the distributor 30 (shown in prior figures).

We claim:

1. A liquid distributing sprinkler comprising:
a frame;
a distributor connected to said frame, wherein said distributor is configured to rotate to distribute a liquid sprayed on said distributor from a nozzle;
a motor connected to said frame, wherein said motor is configured to regulate the speed of rotation of said distributor;
a nozzle carrier, wherein said nozzle carrier is attached to said frame, wherein said nozzle carrier defines a passageway configured for fluid passage through said nozzle carrier,
wherein said nozzle carrier is configured for attachment to a nozzle;
a nozzle carrier, wherein said nozzle carrier is attached to said frame, wherein said nozzle carrier comprises a threaded end, wherein said nozzle carrier defines a passageway configured for fluid passage through said nozzle carrier;
a nozzle, wherein said nozzle is configured for releasable attachment to said nozzle carrier;
a nut, wherein said nut is configured for engagement with an end of said nozzle carrier,
wherein said nut comprises an opening configured such that liquid passing through said nozzle carrier passes through said opening in said nut, wherein said nut is configured to attach said nozzle to said nozzle carrier such that said nozzle protrudes through said opening in said nut such that liquid passing through said nozzle carrier and said nut is directed by said nozzle toward said distributor;
wherein said with said nozzle carrier is configured to receive fluid flow from an external source, said nozzle carrier is configured such that said fluid passes through said nozzle carrier through said nozzle and is directed at said distributor such that rotation of said distributor distributes water in a plurality of directions from said distributor.

2. The sprinkler of claim 1, wherein said sprinkler comprises a seal positioned between said nozzle and said nozzle carrier.

3. The sprinkler of claim 1, wherein said nozzle comprises a locating tab, wherein said nozzle carrier comprises a void configured for mating engagement with said locating tab of said nozzle.

4. The sprinkler of claim 1, wherein said nozzle carrier is releasably attached to said frame.

5. The sprinkler of claim 4, wherein said frame comprises a clamp for attaching said nozzle carrier to said frame, wherein said clamp is configured for circumvolving engagement with said nozzle carrier, wherein said clamp comprises a mechanism to adjust a circumference of said clamp.

6. The sprinkler of claim 5, wherein said sprinkler further comprises a snap ring for connecting said nozzle carrier to said frame.

7. The sprinkler of claim 5, wherein said clamp comprises a generally circular shape defining a circumference, wherein said circumference comprises a gap defined by a first clamp circumference end and a second clamp circumference end, wherein said mechanism to adjust a circumference of said clamp comprises a threaded connector configured for adjusting said gap between said first clamp circumference end and said second clamp circumference end.

8. The sprinkler of claim 1, wherein said nozzle carrier comprises a locating tab, wherein said frame comprises a void configured for mating engagement with said locating tab of said frame.

9. The sprinkler of claim 1, wherein said nozzle carrier is configured to indirectly received fluid flow from an external source.

10. The sprinkler of claim 2, wherein said seal comprises an O-ring.

11. The sprinkler of claim 1, wherein said nozzle carrier comprises a threaded end, wherein said nut is configured for threadable attachment to said threaded end of said nozzle carrier.

12. A liquid distributing sprinkler system comprising:
a frame;
a distributor connected to said frame, wherein said distributor is configured to rotate to distribute a liquid sprayed on said distributor from a nozzle;
a motor connected to said frame, wherein said motor is configured to regulate the speed of rotation of said distributor;
a nozzle carrier, wherein said nozzle carrier is attached to said frame, wherein said nozzle carrier comprises a threaded end, wherein said nozzle carrier defines a passageway configured for fluid passage through said nozzle carrier, wherein said nozzle carrier is configured for attachment to a nozzle;
a plurality of interchangeable nozzles configured for attachment to said nozzle carrier,
wherein said each of said nozzles is configured to spray water at said distributor when attached to said nozzle;
a nut, wherein said nut is configured for threadable engagement with said threaded end of said nozzle carrier, wherein said nut comprises an opening configured such that liquid passing through said nozzle carrier passes through said opening in said nut, wherein said nut is configured to attach said nozzle to said nozzle carrier such that said nozzle protrudes through said opening in said nut such that liquid passing through said nozzle carrier and said nut is directed by said nozzle toward said distributor; and
wherein said with said nozzle carrier is configured to receive fluid flow from an external source, said nozzle carrier is configured such that said fluid passes through said nozzle carrier through a nozzle attached to said nozzle carrier by said nut, wherein said nozzle direct said fluid flow at said distributor such that rotation of said distributor distributes water in a plurality of directions from said distributor.

13. The sprinkler system of claim 12, wherein said plurality of interchangeable nozzles comprise a plurality of nozzles configured for varying flow rates.

14. The sprinkler of claim 12, wherein each of said nozzles comprise a locating tab, wherein said nozzle carrier comprises a void configured for mating engagement with said locating tab of said nozzles.

15. The sprinkler of claim 12, wherein said nozzle carrier is releasably attached to said frame.

16. The sprinkler of claim 15, wherein said frame comprises a clamp for attaching said nozzle carrier to said frame, wherein said clamp is configured for circumvolving engagement with said nozzle carrier, wherein said clamp comprises a mechanism to adjust a circumference of said clamp.

17. The sprinkler of claim 16, wherein said clamp comprises a generally circular shape defining a circumference, wherein said circumference comprises a gap defined by a first clamp circumference end and a second clamp circumference end, wherein said mechanism to adjust a circumference of said clamp comprises a threaded connector configured for adjusting said gap between said first clamp circumference end and said second clamp circumference end.

18. The sprinkler of claim 12, wherein said nozzle carrier comprises a locating tab, wherein said frame comprises a void configured for mating engagement with said locating tab of said frame.

19. The sprinkler of claim 12, wherein said nozzle carrier is configured to indirectly received fluid flow from an external source.

20. The sprinkler of claim 12, wherein said sprinkler system comprises a seal configured to be positioned between said nozzle and said nozzle carrier.
